(19) United States
(12) Patent Application Publication
(10) Pub. No.: US 2010/0289234 A1
(43) Pub. Date: Nov. 18, 2010

(54) Advertising Frame for Shopping Cart

(76) Inventors: Horst Sonnendorfer, Puchheim (DE); Franz Wieth, Puchheim (DE)

Correspondence Address: LERNER GREENBERG STEMER LLP, P O BOX 2480, HOLLYWOOD, FL, 33022-2480, US

(21) Appl. No.: 12/811,974

(22) PCT Filed: Sep. 9, 2008
(86) PCT No.: PCT/DE08/01503

§ 371 Date: Jul. 7, 2010

(30) Foreign Application Priority Data
Oct. 30, 2007 (DE) 20 2007 015 159.4

(51) Int. Cl. G09F 3/16; G09F 3/20; G09F 21/04; B62B 3/14

(52) U.S. Cl. 280/33.992

(57) ABSTRACT

An advertising frame is disposed as an inverted U-shaped strip around the upper edge of a basket of a shopping cart. The advertising frame is elastic and is placed onto the edge of the basket in a clamping manner.

### TECHNICAL FIELD

The invention relates to an advertising frame for fitting on the upper periphery of the main body of a shopping cart.

### PRIOR ART

U.S. Pat. No. 1,116,942 discloses an advertising frame which is arranged on the upper periphery of the main body of a shopping cart. This advertising frame, however, is arranged only on certain regions of the periphery of the shopping cart and does not give the impression of being homogenously integrated in the shopping cart.

The fastening elements are of complex configuration, and this disadvantageously makes it more difficult to change over the advertising content. In addition, the advertising frame is interrupted in the region of the fastening elements, and this is disadvantageous from a visual point of view.

### DISCLOSURE OF THE INVENTION

### Technical Problem

The problem of the invention is to provide an advertising frame which is intended for fitting on the upper periphery of a shopping cart and in which fastening is uncomplicated, the advertising content can be changed over quickly and easily and the advertising surface is not interrupted by the fastening elements.

### Technical Solution

This problem is solved by an advertising frame which is fitted in the manner of a strip along the upper periphery of the main body and has transparent regions behind which advertising material can be fitted. The considerations which gave rise to the present invention were based on the fact that a strip which is made of elastic material, which has, on its inner side, a contour adapted to the wire profile and which can be plugged in a clamp-like manner onto the upper periphery can be fixed on the shopping cart without any further fastening materials being used.

In a development of the invention, the retaining action is further enhanced by an additional fastening element, although the latter does not obstruct the advertising surface.

In a further embodiment of the invention, the advertising frame is shaped such that the transparent regions are set back to some extent, as a result of which they are more protected against damage.

### Advantageous Effects

The strip gives rise to a uniform appearance which is not interrupted by any fastening means.

### BRIEF DESCRIPTION OF THE DRAWINGS

The invention will be explained in more detail with reference to two figures, in which

FIG. 1 shows the upper corner region of the main body of the shopping cart with the advertising frame, and

FIG. 2 shows a detail of the advertising frame from FIG. 1.

The main body 1 of the shopping cart is illustrated only schematically in the figure. The latter shows a multiplicity of vertical rods 2 which are connected to the wire periphery 3 running all the way around the main body 1. The illustration depicts the advertising frame 4 as being interrupted, so that it is possible to see the position of the wire periphery 3, but in actual fact the advertising frame runs in one piece, without any interruptions, from one corner of the main body 1 to the other corner of the main body 1.

The advertising frame 4 according to the invention is of essentially U-shaped configuration and is plugged on over the wire periphery (3) from above. Connecting elements 5 are provided in the corners of the main body 1.

The connecting elements 5 are shaped in adaptation to the angle and the radius of curvature of the wire periphery 3. The connecting element 5 engages over the advertising frame 4 in a clamp-like manner.

FIG. 2 shows a detail-form view of the special design features of the advertising frame 4 according to the invention.

That region of the advertising frame 4 which encloses the wire periphery 3 in the plugged-on, installed state is provided with undercuts 4a. This gives rise to a form fit and increases the strength with which the advertising frame 4 is seated on the wire periphery 3.

On that side of the advertising frame 4, which, following installation, is located on the outer side of the main body 1, the profile is set back in the region 4b.

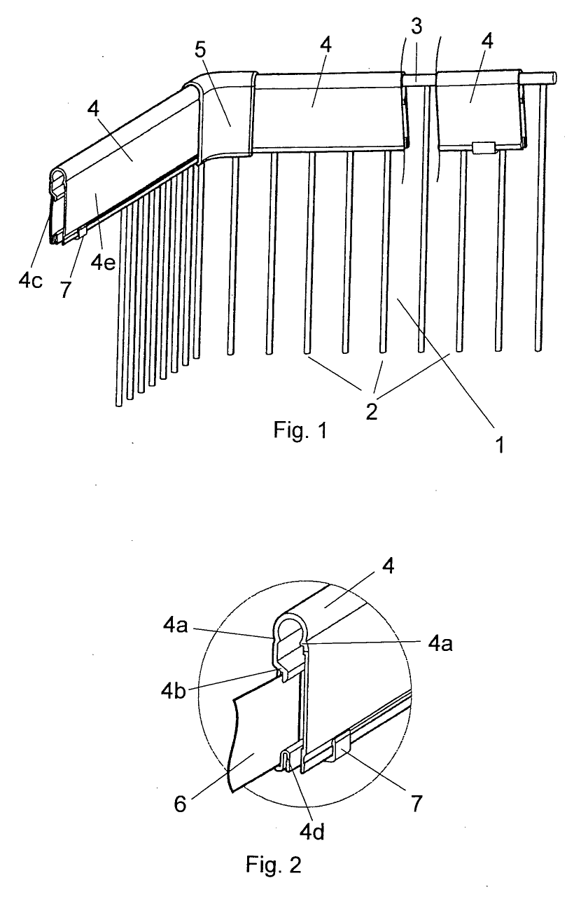

A groove into which a strip-form advertising carrier 6 can be pushed is produced between a transparent region 4c, which can be seen to better effect in FIG. 1 than in FIG. 2, and the region 4b.

The profile is likewise configured on the lower periphery 4d such that there is a groove produced for the strip-form advertising carrier 6. The advertising carrier 6 is thus guided reliably from two sides by the groove-like regions 4b and 4d.

The transparent region 4c is set back to some extent in relation to the region which encloses the wire periphery 3. This means that the transparent region is protected when the shopping cart comes into contact with another object, for example when it strikes against a rack during use. The transparent region is also protected when the shopping carts are pushed one inside the other in a parking region.

The result of a transparent region 4e located on that side of the advertising frame 4 which, following installation, is oriented toward the inner side of the shopping cart. A strip-form advertising carrier can be pushed behind this transparent region 4b. Steps which keep the strip-form advertising carrier in position are located above and beneath the transparent region 4e.

The legs of the U-shaped advertising frame 4 are held together by a clamp 7. The clamp 7, once the advertising frame 4 has been plugged onto the wire periphery 3, is fastened and prevents the U-shaped legs from being bent open. With the U-shaped legs fixed together, the undercuts 4a engage around the wire periphery 3 and, as already explained above, give rise to a form fit.

The legs of the advertising frame 4 butt against the vertical rods 2 of the main body 1. The vertical rods 2 have a smaller diameter than the wire periphery 3 of the main body 1. The profile of the advertising frame 4 is coordinated with these different diameters. The set-back, transparent region 4c and the groove-like regions 4b and 4d are configured such that the groove-like regions 4b and 4d butt directly against the vertical rods 2.

In addition, it is possible for one or more RFID means to be accommodated in the advertising frame, as a result of which the advertising frame 4 has an additional function as an RFID holder.

The advertising carrier can also be used for shopping carts with main bodies made of plastics material; adaptation of the profile may then be necessary, but the functioning remains the same.

### INDUSTRIAL APPLICABILITY

The invention is industrially applicable as an accessory for shopping carts.

1-5. (canceled)

6. In combination with a shopping cart having a main body with an upper periphery, an advertising frame assembly for the shopping cart, comprising:
an advertising frame formed as a U-shaped strip made of elastic material, said U-shaped strip having an inner side with a contour adapted to a profile of the upper periphery of the main body of the shopping cart, and being configured to be plugged onto and clamped over the periphery of the main body.

7. The advertising frame according to claim 6, wherein said U-shaped strip is formed as an inverted U with legs, and further comprising an additional fastening element for fixing said legs of said U-shaped strip without obstructing and advertising surface formed on said advertising frame.

8. The advertising frame according to claim 6, wherein said advertising frame is formed with transparent regions and said transparent regions are set back from a remaining surface of said frame.

9. The advertising frame according to claim 8, wherein said transparent regions are bounded by grooves forming a guide for interchangeable inserts carrying imprint thereon.

10. The advertising frame according to claim 6, wherein said advertising frame is formed with structural locations for integration of one or more RFID transponders in said advertising frame.

11. The advertising frame according to claim 6, which further comprises one or more RFID transponders integrated in said advertising frame.
